(19) United States
(12) Patent Application Publication
(10) Pub. No.: US 2012/0024780 A1
(43) Pub. Date: Feb. 2, 2012

(54) Water treatment plant for combined biomass and biogas production

(76) Inventors: Herman Carr, Enskede (SE); Tommy Landberg, Taby (SE)

(21) Appl. No.: 13/134,892

(22) Filed: Jun. 20, 2011

Related U.S. Application Data
(60) Provisional application No. 61/398,108, filed on Jun. 21, 2010.

(51) Int. Cl. C02F 3/32; C05F 11/00; C02F 3/34; C02F 3/00; C02F 3/30

(52) U.S. Cl. 210/602; 210/150; 210/151; 71/11

(57) ABSTRACT

A waste water treatment system is provided that includes a basin for holding water; nitrifying and denitrifying bacteria; macroalgae; and a biobed having a at least one layer and being constructed of materials selected to provide sufficient level of pH for enabling bacterial growth. In the biobed de-nitrification and nitrification bacterial processes are separated. Oxygen produced by algae is used by the nitrifying bacteria. Water is provided continuously to the biobed at an inlet and exits the system downstream after having gone through the biobed. The system may be used with waste water in water treatment plants, domestic waste water (sewage), waste water from diverse industries, drain water from waste deposits, runoff water from roads, water waste treatment and recycling plants, agricultural and farm land and surrounding land of populated areas. The algae and bacteria are combined for symbiotic remediation of water that may be flexibly controlled to adapt to a broad range of applications.

### CROSS-REFERENCE TO RELATED APPLICATIONS

This application claims priority from U.S. Provisional Application Ser. No. 61/398,108 filed Jun. 21, 2010.

### FIELD OF THE INVENTION

The present invention relates generally to water treatment plants, domestic waste water (sewage), waste water from diverse industries, drain water from waste deposits, runoff water from roads, water waste treatment and recycling plants, agricultural and farm land and surrounding land of populated areas. More specifically this invention combines algae and bacteria for symbiotic remediation of water in a new innovative geometric construction giving outstanding fine tuning control as well as flexibility to adapt to a broad range of applications.

### BACKGROUND OF THE INVENTION

Large outlets of water affected by man are a major problem around the world. Cleaning wastewater, and in particular sewage is related to high costs and a high amount of waste products. Current methods for water cleaning include: mechanical treatment i.e. filtering; chemical treatment such as precipitation of phosphorus using ferric compounds, and biological solutions using bacteria to convert nitric compound to nitrogen gas. All these methods are commonly used together for maximum cleaning effect. Another method is construction of wetlands where nutrient and toxic compounds are either taken up by plants or precipitated into the sediment.

A typical sewage treatment involves three main stages:

a) temporarily holding the sewage in a quiescent basin where heavy solids can settle to the bottom while oil, grease and lighter solids float to the surface. The settled and floating materials are removed and the remaining liquid may be discharged or subjected to secondary treatment. Chemicals for precipitation of phosphorus may be added at an early stage;

b) removal of dissolved and suspended biological matter. This stage is usually performed by indigenous, water-borne microorganisms in a managed habitat. This secondary treatment may require a separation process to remove the microorganisms from the treated water prior to a posterior treatment; and

c) treated water is disinfected chemically or physically prior to discharge. When needed more chemicals are added to precipitate phosphorus.

The second stage substantially degrades the biological content of the sewage but is one of the most expensive tasks in the treatment plant as an air supply from air pumps or turbines is required. Bacteria and protozoa consume biodegradable soluble organic contaminants such as sugars, fats, organic short-chain carbon molecules, etc. and bind much of the less soluble fractions into flocs or flakes. This process is commonly aerobic. Nitrifying bacteria and other bacteria use air or oxygen for the breakdown of organic matter. Air supply is a costly process, which often accounts for at least half the cost of a sewage treatment plant. Nitrifying bacteria in combination with de-nitrifying bacteria convert bound nitrogen to nitrogen gas that is released to the air. Recent methods use both types of bacteria as nitrifying bacteria reduce ammonia to nitrate and de-nitrifying bacteria reduce nitrate to nitrogen gas.

It is also essential to remove phosphates from wastewater because phosphorous, one of the main constituent of synthetic detergents and feces, can cause eutrophication of surface waters. Current methods include chemical precipitation, which is expensive and causes an increase of sludge volume by up to 40% and biological phosphate removal (BPR). The principal advantages of biological phosphorous removal are reduced chemical costs and less sludge production as compared to chemical precipitation. In this process the phosphorous in the influent wastewater is incorporated into cell biomass, which is subsequently removed from the process as a result of sludge wasting.

Algae may be used to remove excess nutrients from water. Briefly, algae can be divided into three key groups: green, brown, and red algae, which holds several groups containing both micro- and macroalgae. This systematic classification is mostly based on the composition of pigments involved in photosynthesis. Algae grow both free floating and attached to surfaces such as for example rock, stones or other algae. Algal turfs are communities of organisms dominated by aggregations of unicellular to branched filamentous algae and cyanobacteria (so called blue-green algae). They attain a canopy height of only 1 to 10 mm. These microalgal species clean water to a very high quality, and remove CO₂ from the atmosphere by capturing solar energy at high rates. Algal turfs are only very weakly inhibited by low nutrient levels. Individual cells are able to uptake carbon, nitrogen and phosphorus at fractions of ppb levels. This lack of sensitivity to nutrient concentration, until extremely low levels are achieved, provides the ability to accomplish high water purity. Thus, algae turfs are known to be efficient scrubbers of a variety of pollutants found in wastewater. Their action results in production of biomass and oxygen. Also, they raise the pH of the water during light hours. Algal turfs containing cyanobacteria are also used as nitrogen-fixing organisms.

Macroalgae are larger plants (canopy height usually >10 mm), which can be observed without using a microscope. They take a wide range of forms, ranging from crusts, leafy and filamentous forms to more complex forms with highly specialized structures. Macroalgae have many commercial and industrial uses and are cultivated at the coast in order to improve yields and to lessen the impact on natural stands of macroalgae. Macroalgae contains members of all types of algae.

Microalgae, on the other hand are unicellular, and sometimes filamentous, microscopic algae, typically found in freshwater and marine systems. Their cell sizes can range from a few micrometers (μm) to a few hundreds of micrometers.

Land based treatment plants relying on microalgae and experiments with High Rate Algal Ponds (HRAP) (i.e. Oswald and Gotaas, 1957) were carried out as early as in the 1950's and the algae were regarded as a source for fuel production. In HRAP's symbiosis is obtained between algae and microorganisms (bacteria). The algae produce oxygen that the bacteria use for the breakdown of organic matter, which in turn releases carbon dioxide that the algae use. A HRAP is usually constructed as an open race pond with a meandering system and a paddlewheel to increase the water flow through the system. Recent improvements of HRAP have been achieved by adding a de-nitrification step. A portion of the algae is used as a carbon source for the de-nitrifying bacteria in an oxygen free compartment (Neba and Rose, 2004). However, such systems often require either several ponds or very large ponds, in order to collect the microalga through sedimentation. Besides, there is also required to have a system that retains the microalgae in the water except at harvest.

U.S. Pat. No. 5,846,423 discloses a wastewater cleaning method that relies on the use of turf algae and macroalgae. In this system algae increase the pH just outside the cell wall of the algae while the pH of the surrounding water body is maintained through pH adjustment. This will in turn precipitate phosphorus onto the alga surface. No biobed (i.e. bacteria) is used and hence the positive effects of bacteria are not utilized. Furthermore, no measure is taken to maintain the pH upon respiration, which will negatively effect the precipitation of phosphorus. On the other hand, in this method, a turf community consisting of a mixture of filamentous algae and animals on an uneven surface is created. Such an algae turf community is scraped off and smaller; and newly settled algae remain on the uneven surface. Thus, special care has to be taken when harvesting turf algae in order not to flush out the algae, which usually fragments upon harvest.

Larsdotter (Larsdotter 2006) describes a method also using algae to clean wastewater. The method is based on the use of microalgae to eliminate phosphorous. Microalgae in solution are allowed to increase the pH in a pond, which will cause the phosphorus to precipitate to the bottom. As microalgae tend as well to move with the water flow, care has to be taken to not flush out the algae, which makes such system difficult to manage. In this regard, the use of macroalgae can offer several advantages. Macroalgae, could be harvested/collected in streaming water with much more ease than microalgae. Also, macroalgae can grow unattached in the water column, which makes harvest easy as the alga have positive buoyancy.

In prior methods such as the one described U.S. Pat. No. 5,846,423, where the algae must be scrapped off and HRAP, where the algae must be allowed to sediment in a second pond (a difficult process) or collected by other means, the process of gathering the algae becomes very troublesome and expensive. Thus, there is a need for a method as the one described in the present invention, wherein the algae are easily gathered on the surface.

An alternative method is described in Korean patent KR20020061991. In this case, Cladophora spp, a branched green filamentous macroalgae, is used to clean wastewater. The system employs cages or containers containing Cladophora that are placed in the water such as a lake. Cleaning will then occur when removing the cages.

In general, the main problems of conventional methods include: high costs, generation of increasing amount of waste products and toxic aerosols; and need for aeration and high-energy inputs.

The invention herein solves the problems of the prior art by providing a biological process in which macroalgae and bacteria are combined in a novel geometric construction for a symbiotic system. The system of the invention decreases the need for energy and chemicals as compared to commonly applied methods. Furthermore, the method herein disclosed produces biomass which is very suitable for energy production e.g. biogas.

Other objects and advantages will be more fully apparent from the following disclosure and appended claims.

### SUMMARY OF THE INVENTION

The invention herein provides a waste water treatment system, comprising a basin for holding water; nitrifying and denitrifying bacteria; macroalgae; and a biobed having a plurality of layers and being constructed of materials selected to provide a sufficient level of pH for enabling bacterial and algal growth, in which biobed de-nitrification and nitrification bacterial processes are separated spatially and wherein oxygen produced by algae is used by the nitrifying bacteria; and wherein water is provided continuously to the plurality of biobed layers at an inlet and exits the system downstream after having gone through the biobed.

A primary object of the present invention is to provide a system for cleaning of nitrogen, phosphorus and BOD (biochemical oxygen demand) in water and for the cultivation of algae. The algae are very suitable for energy production and as fertilizer.

Another object of the present invention is to provide substrate and habitat for naturally occurring bacteria, which carry out nitrification, de-nitrification and break down organic matter.

Another object is to make an innovation based on naturally occurring processes controllable and predicable.

Another object is to utilize the cleaning of compounds as nutrient and, thus, produce biomass, well suitable for energy production (e.g. production of biogas).

Another object is to provide a method in which the alga e.g. macroalgae, may be easily harvested/collected on the water surface.

The invention herein provides novel geometric constructions that have the following properties:
Multiple layers, which includes both oxygen rich and oxygen reduced zones.
High flexibility for adaptation to a very broad range of application.
High flexibility for construction on site, resulting in low construction costs.
High ability both in the short and long term to achieve very high efficiency.
Low cost of construction and maintenance.
Efficient production of biomass, suitable for energy production.

The geometric construction itself requires an area exposed to sunlight or to other light source (area size dependent on cleaning needs) and a receiver of the biomass, e.g. a biogas production plant.

### BRIEF DESCRIPTION OF THE DRAWINGS

FIG. 1. Side view of two possible construction solutions to achieve vertical layering with low oxygen levels in the lower part of the constructions. The loose layer may be set to achieve a stronger separation between upper and lower layers and may consists of cloth of persistent material that does not degrade easily. At the top of the stones, a high density of algae aids in creating a vertical differential of oxygen content closer to the surface if desirable, as the lower algae layer will be self shaded and algal respiration will consume oxygen.

FIG. 2. Depicts the cross-section of a solution when the construction pond is too deep (>1.0 m). The two-layered system, which is the same as in FIG. 1, is encapsulated in rubber sheets and is held up by floating units (fenders) and some supporting construction in wood. This construction is useful for pre-existing ponds and is insensitive to variations of pond depth. If desirable, the rubber sheet can extend to the bottom of the pond.

FIG. 3. Top view of a solution to achieve locally low oxygen pockets in a water stream. Such solutions are important where large variations in water flow occur seasonally and where daily changes and tuning of the system are difficult. Lowering the amount of water passing and by physical hindrance (resistance) creates zones of lower oxygen and facilitates the vertical differential in oxygen content.

FIG. 4. Photosynthetic light response curve of algae used in the invention in all examples. The water originates from a source corresponding to example 2.

FIG. 5. Example of laboratory growth of the algae utilized in the invention in water from a stream suitable for the invention as in example 2 (n=2-3, ±SE). Zero growth is predicted from a photosynthetic light response curve and the light compensation point from FIG. 3.

### DETAILED DESCRIPTION OF THE INVENTION AND

### Preferred Embodiments Thereof

The aim of the present invention is to remove compounds, such as nutrients, from water using a combination of organisms including but not limited to macroalgae, microalgae turf alga, and bacteria. The process is driven by sunlight energy, or artificial light. It produces oxygen that can be used in oxygen consuming processes and makes use of the nitrogen, phosphorus and organic matter in the water for the production of biomass. The biomass is of economical value. For instance, by harvesting the algal mass, different processes can be used to produce biomass that can later be used as an energy source to produce biogas, methane or ethanol, as a fertilizer or as a human or an animal food additive or supplement, cosmetic or pharmaceutical, etc.

This invention relies primarily on the use of macroalgae and functions by similar principles as the HRAP (discussed above) for the supply of inorganic carbon to the algae and for production of oxygen to heterotrophic bacteria or bacteria using organic carbon compounds as carbon source. However one of the unique solutions of this invention is the employment of a geometrically layered biobed, where de-nitrification and nitrification processes are separated in space but not in time; and the oxygen from the algae is utilized for the nitrifying bacteria. This system is an economical and innovative solution to create zones for the continuous de-nitrification and nitrification process during algae cultivation.

In sewage treatment plants the pH has usually to be kept at around 7 and slightly lower, due to a neutral pH is optimal for the bacteria that carry out the biological processes. In the invention herein, no means are employed to maintain the pH constant in the water body above or around algae; instead, the pH is allowed to rise (normally from pH 6-7) during algal photosynthesis. Precipitation of phosphorus occurs spontaneously as pH values increase (up to pH 9 and slightly above). The highest increase of pH occurs in close proximity to algae at the upper zone where carbon dioxide is consumed by the algae in the light hours and where nitrifying bacteria also consume carbon dioxide. Since the construction is double layered, very little phosphorus will precipitate at the lower layers, where pH values usually are 6-7 or below. The pH is lower in the lower layer due to the breakdown of organic material, which causes release of CO₂.

Moreover, the method of the invention allows removal of phosphorus through bacteria growing on the surface of the algae, and sedimentation of bacteria onto the algae. The phosphorus is removed when harvesting both algae and bacteria, as compared to traditional water cleaning methods where only the bacteria that lacks a substrate is removed.

In the invention herein, a biobed is carefully constructed of selected stones considering the CaCO₃ content of the water and the surrounding area. The biobed is constructed for enabling thriving of bacteria. The bacteria can either be added or allowed to grow naturally from the surrounding environment. Materials other than stones can also be used as a substrate for bacteria. Areas with limestone, a sedimentary rock composed largely of crystals of CaCO₃, will have a high pH, above pH 7 and around pH 8. Woodlands and areas without limestone usually have pH values below 7. In such cases, limestone can be mixed into the biobed, completely or partly. Limestone can be purchased at a natural finding or smashed concrete blocks can be used, as it contains CaCO₃. Limestone or stones containing CO₃ will increase the pH upon wetting and buffering the water when CO₂ is released from the algae and bacteria through respiration. The calcium from the limestone is also required by Cladophora, the macroalgae used in the present invention.

Some of the phosphorus from the water can also be absorbed by positively charged limestone mixed into the biobed. Greystone, or acid stone, is also suitable in areas where the pH is above 7 and where there are Ca ions in the water. Acid stones are not acid as the name implies, however, greystones like granite, withstand weathering better than limestone. Therefore the pH is not likely to be raised by greystones even tough dissolved dust of granite or gneiss would raise the pH. The substrate for the biobed could also consist of for example LECA® grains (Light Expanded Clay Aggregate) mixed with heavier stones. The grain is a naturally occurring material composed principally of silicates of alumina, with no acid or alkaline characteristics. The smaller LECA® grains (AB Svensk Leca, Linkoping, Sweden) will give a larger surface for the bacterial biofilm per volume water. Furthermore, these grains are easy to handle when put in jute-hessian bags (Blue pack, Löddeköpinge, Sweden) that can later on be easily placed in water with bricks and stones on top. The LECA® low density in combination with its good price makes it an interesting material for systems installed in deep ponds (deeper than 1 m). In general, no special chemicals or chemical composition of stones is required. However, by choosing the type of stones the pH can be adjusted close to the bacteria and algae for optimal pH. Careful selection of the type of stones is an important factor for optimization of the system.

This invention might also use turf algae in those situations when conditions are more suitable for smaller filamentous algae and cyanobacteria. For instance, when treating heavily polluted wastewater such as incoming wastewater with nitrogen around and above 40 mg/L and/or cold water temperature, continuously below 10° C. and periodically close to freezing temperature. Notwithstanding, as mentioned above, this invention mainly utilizes a single, well-defined, macroalgae or aquatic plant such as Cladophora spp. However it is not limited to a specific species of macroalgae.

In the invention herein the algae are maintained as a bundle of filaments and is collected without the necessity of changing the direction of, or cutting off, the water. The invention includes a system for cultivation of Cladophora, or other algae, aquatic plants and bacteria. The water is led into a system where water is kept flowing. The process is continuous in contrast with prior methods in which cages of Cladophora are placed into for example a lake. The benefit of this system, among others, is the cleaning effect that also occurs through the biobed and the symbiosis between alga and bacteria and that harvest is facilitated through water flow. Further this invention can be built into already existing water formations such as a stream. In such cases the stream is modified into this system for water cleaning and biomass production.

The invention herein is carried out in the following way:

a) Typically the water enters at the inlet at the upper layer. As the water flows through the system it is allowed to be mixed into two layers: a lower layer around the deepest part of the biobed with de-nitrifying bacteria and an upper layer with algae and nitrifying bacteria.

b) In the lower layer organic material is broken down by bacteria consuming available oxygen in water, the oxygen is supplied at a low rate from the upper layer by diffusion and by mixing of water with the upper layer. Organic material is reduced at the same time as CO₂ is released to the upper layer. In the oxygen poor environment de-nitrifying bacteria use ammonia instead of oxygen as an electron donor, and thereby oxidize ammonia to nitrate.

c) In the upper layer nitrifying bacteria grow at the expense of the inorganic carbon released from organic material. The nitrifying bacteria reduce nitrate to nitrogen gas, which is harmless for the environment. In the upper layer the algae produce oxygen and grow to yield biomass. The oxygen is used for breakdown of organic material both in the lower and upper layer. When algae grow through photosynthesis, carbon dioxide is consumed, which increases the pH in the proximity of the algae. The rise in pH causes phosphorus to precipitate. Water leaves the system of the invention at the outlet after having gone through the length of the entire system.

Biobeds

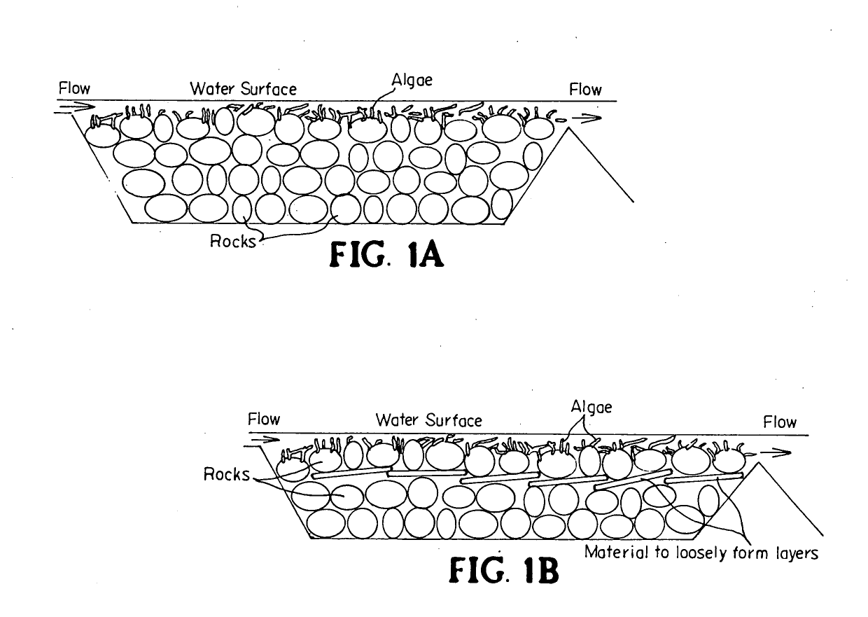

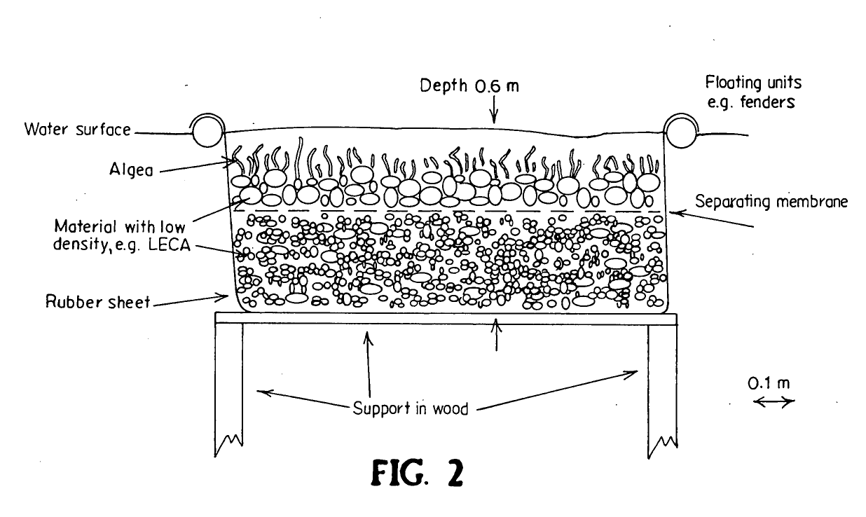

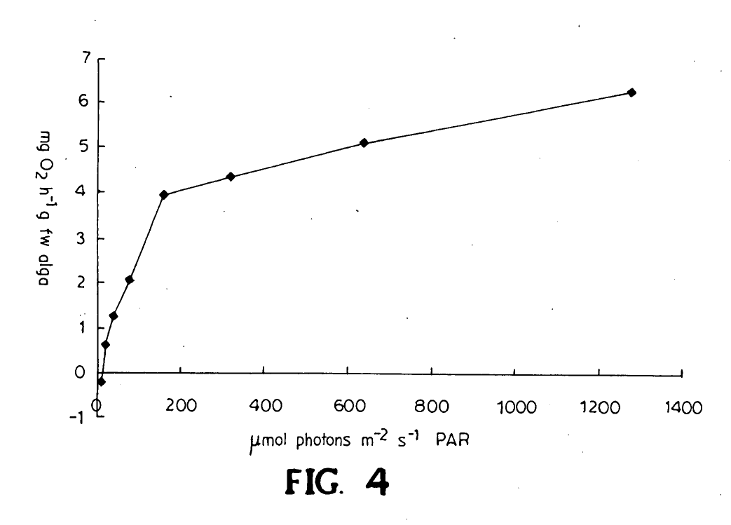

It is of large importance that a biobed is constructed at the bottom of the pool of this invention, which increases the attachment surface for the bacteria and provides substrate for attachment of algae. The biobed can be constructed as a two-layer biobed (FIG. 2) or as one layer biobed with an oxygen concentration gradient (FIG. 1) The deepest part of the biobed is constructed in such a manner that oxygen free or oxygen low (preferably below 0.2 mg/L dissolved oxygen) zones are created, which facilitates de-nitrification. Due to friction, a lower water speed is obtained at the lower zones, which causes some accumulation of organic material. At the inlet of the two-layer biobed, a smaller part of the water is transported down into the zone of lower oxygen content, which provides organic carbon to the de-nitrifying bacteria. Breakdown of organic matter at the lower zone releases carbon dioxide, which is beneficial both to the alga and the nitrifying bacteria at the upper zone that prefer inorganic carbon instead of organic carbon. Note that the geometric construction consists of several modules in a series to allow water to reach both the upper and lower zones. Since organic matter has a tendency to accumulate at the bottom where it is broken down, the upper oxygen rich zone will have a lower level of organic carbon (organic matter is also rapidly broken down at the upper zone due to high oxygen content combined with the effective biobed). This is important as high organic content may inhibit growth of the sensitive nitrifying bacteria (nitrifying bacteria are easily suppressed by de-nitrifying bacteria when organic material is abundant, while nitrifying bacteria make use of inorganic carbon. The biobed can be constructed of stones, bricks, broken concrete blocks, LECA® grains or other sort of grains as described above. To increase the surface area for biofilms, glass fiber nets can be inserted to preferably the lower level and textile fiber mats can be inserted to the upper layer. A tight glass fiber net or mat can also function as a membrane (see below). The Swedish company Esska teknik is a supplier of glass fiber mats that are used as air filters. These glass fiber filters are suitable for use both as a membrane between the two layers and to enhance the surface in the protected lower layer. At the upper layer textile nets can be used and placed close to the bottom of the top layer. It is important that the net is anchored with stones or bricks to make sure the net will not follow the alga at harvest. Heavy mats or nets made of coconut fiber (Byggros, Önnestad, Sweden) can be used at the top layer. In fact, all kinds of textiles, and surface giving structures can be inserted into the layers. For instance, all material that will produce a large surface area per volume water and that can be maintained inside the system. For example the mat effectively provides surfaces to bacteria and turf algae and will not be removed at the harvest of macroalgae (as would occur when using conventional biobed bacteria carriers used in sewage treatment plants). The cleaning effect is based both on the biobed activity in the lower layer as well as diffusion of compounds from the upper and lower layer. The surface of the biobed is increased in the upper layer by placing nets anchored below stones (but not limited to stones) as described above. Water enriched in oxygen by the help of algae may also be pumped to the conventional aeration pool of a waste water treatment plant (bioactive sludge pool) if desirable, and thereby, reduce the cost and need of aeration through turbines or air pumps. The algae we used have high oxygen productivity, see FIG. 4. Already in the second week of March (early spring/late winter in Sweden) we measured 430 μmol photons m⁻² s⁻¹ about 20 cm below the water surface, with sunlight at the surface of 730 μmol photons m⁻² s⁻¹.

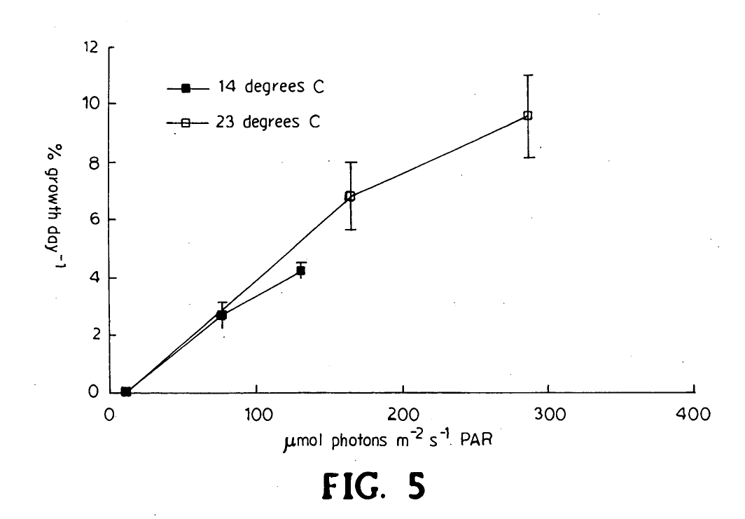

In the invention herein, the algae are harvested repeatedly for a more effective cleaning. This is advantageous as compared with wetlands where the biomaterial can leak nutrients during winter months due to biomass degradation in wetlands. After harvesting the algal mass, we have been able to measure a high productivity of biomass, even at low light intensities (FIG. 5).

Separation of Biobeds

While high oxygen concentration inhibits de-nitrification processes, establishment of oxygen low zones is also of major importance. This invention is based on experiments using different types of “zone-separators” and the choice of separator is critical. A membrane consisting of a glass fiber mat with sediment or sand in between two layers of geotextile gives satisfactory results (but different kinds of textile also work). Byggros, Önnestad, Sweden is a supplier of woven geotextiles. By simply constructing a layer of “roof bricks” with some narrow spaces in between a barrier is provided between oxygen richer and oxygen poorer water in heavily polluted water (for example nitrogen around and above 40 mg/L). However, such a barrier does not work in mildly polluted water (for example nitrogen around and below 15 mg/L). Our results show that the oxygen concentration is rather high beneath the bricks when there is abundant oxygen present at the top layer produced by photosynthesis. For example, when there is abundant sediment or particles in the water, zero oxygen was obtained, both under the bricks and our membrane described above, at oxygen concentration at the top layer of approximately 10 mg O₂/L. At similar conditions with sediment or fewer particles present, or at higher oxygen concentration in the water above the bricks, oxygen concentrations can be up to 4 mg O₂/L (or even higher) under the bricks, while under our membrane we measured oxygen concentration to be close to zero. For this reason we constructed the membrane, instead of only using bricks as a separator of the two layers. The thickness of the membrane is variable and can be changed by adding different amounts of sand or gravel. The membrane thickness should be from 1 millimeter to 7 centimeters. However it can also be of less than a millimeter when using different types of geotextiles. This flexibility is important as more polluted water needs a thinner membrane as compared to less polluted water (heavily polluted water consumes oxygen more readily and less separation of the two oxygen layers are needed). The membrane allows passage of ions, which is important because nitrate needs to be transported from the top level to the bottom level for de-nitrification and ammonium needs to be transported from the bottom level to the top level for nitrification. Gases (dissolved in the water) move through the membrane as well, but at a lower speed, which creates a sufficient oxygen gradient.

When there is an abundant layer of algae, which causes shading at the deepest layers of algae, the shading will lower the oxygen production at the deepest part. This will in turn increase de-nitrification. Thus, it is possible to control or affect the process of de-nitrification by the amount of algae that is harvested. Oxygen evolution decreases as a function of self-shading in mats of Cladophora (Higgins, 2005).

When having abundant algae, at temperatures above 10° C., with the membrane partly installed and surface yielding structures for biofilms; the removal of nitrogen increased from close to zero percent to eight percent, measured as the difference of incoming and outgoing nitrate and ammonia (as compared without these features). This was measured at a test plant that functioned as a polishing step of outgoing water from a sewage treatment plant. With a fully optimized system the removal of nitrogen will increase further.

Construction of Channels

By narrowing the passage of water by constructing channels, the speed of water is increased, which is important for the growth of algae and mixing of water. In a so-called race pond of microalgae described previously as HRAP, the walls of the channels are fixed in height or depth. On the contrary, in our system, the walls can be both fixed in height or move with the water level, as the top of the wall is floating with the help of any suitable floating device such as a fender (FIGS. 1 and 2). It is important that the walls do not protrude excessively out of the water surface, as the walls will cause shading. Likewise, it is important that the walls of the channels are thin so more space can be utilized to cleaning water and growing algae. In an environment with an even and stable flow of water, fixed walls, made out of any suitable material, can be used. However, in an environment with varying amounts of water and water levels, the walls can be constructed out of rubber sheet attached to a floating pipe, such as in example 2. The rubber sheet can be attached to the bottom with the help of weight and at the sides with suitable material depending on the location. The benefits of “floating walls” include less shading and that the walls enable mechanical harvest of the algae, as the walls can be pushed down under the water and allow the passage of algae. Other benefits are that the walls are easy to install and inexpensive to construct.

Pre-Fermentation and Pre-Sedimentation

In heavily polluted water, pre-fermentation and pre-sedimentation are required to increase the effectiveness of our system as we discovered that the oxygen concentrations are too low to allow respiration in some algae despite there being some photosynthetic activity. A pre-fermentation step, consisting of a large and deep container that allows settlement of organic matter and fermentation, allowed a breakdown of oxygen consuming substances e.g. organic matter in raw sewage. The proposed pre-fermentation step enables production of higher oxygen content through photosynthesis as compared with a system obviating said step. Our results show that close to the inlet of the system for raw sewage water and after the pre-fermentation step, the oxygen concentration was very low 0 to 0.5 mg O₂/L while closer to the outlet of our system the oxygen concentration was 2.0 mg O₂/L.

Applications

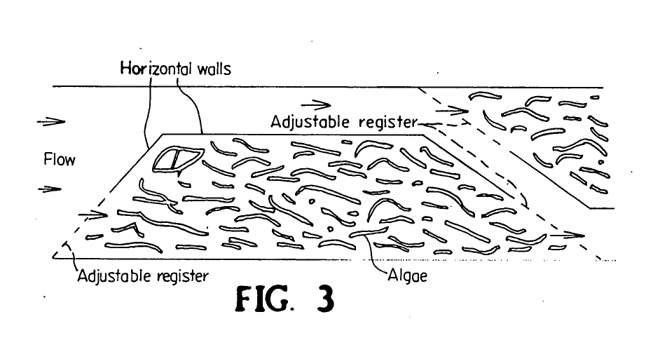

Unlike wastewater treatment plants, natural streams in the landscape involve certain concerns with regard to nature preserving issues, water velocities and the amount of water passing through, existing topography, the geology of the area and the use of surrounding land. In order to create areas with lower flow velocities and lower oxygen concentrations for de-nitrification processes systems, open cells surrounded by walls are constructed of materials comprising but not limited to low cost material such as wood and rocks (FIG. 3). Other materials such as burned clay, recycled glass, clean rest product from mining may work as well. The lower flow velocities at the sectioned parts also helps maintaining the bacteria culture for breakdown of organic matter and nitrification and allow pH to rise at sunny days through photosynthesis. This solution will allow fish to pass freely.

Depending on the amount of nutrients in the water and the proportion of ammonium and nitrate, the biobed can either consist of a single layer or a multilayer. As flow decreases as a consequence of the friction caused by the bottom and the biobed material, the flow velocity will be lowest at the bottom of the biobed as compared to higher up in the biobed.

The invention can also be applied to storm water, waste deposit drainage water and runoff water from roads. Storm water treatment may likely need ponds buffering large fluctuations in water amounts. Waste deposit drainage water, and also water from roads may need a heavy metal trap (not shown here). Both example 1 or 2 can be used to clean the water from the paper and pulp industry depending on the variation of water amounts.

Harvest

Harvest is performed periodically to avoid self-shading and to maintain a high growth and nutrient uptake and a high oxygen production of the standing crop of algae and aquatic plants. The excess (harvested algae) contains nutrients that are removed from the system and that can be used for biogas production and as a fertilizer. Details of the harvesting are not described here, but include and are not limited to, mechanical harvest and pumping of both algae and water.

Management and Control of the System

Different environments including sewage treatment plants have different needs with regards to cleaning of certain compounds and it can change from one week to another depending on the process status of the treatment plant. The system of the invention is very flexible and can meet such demands. By measuring a few parameters such as oxygen content, pH, flow and the nutritional status of the water, the invention can easily be integrated to the software or operating system of a sewage treatment plant. Global Water (USA) is a supplier of online and logging system for measuring environmental factors such as oxygen content. More or less permanent changes can also be done in order to meet specific demands. For example, if phosphorus removal is the main object, the biobed can be built smaller in order to lower carbon dioxide production and ammonia removal, which will result in higher pH and precipitate phosphorus to a higher degree. This process also results in a higher oxygen concentration in the water, as less oxygen consumption will occur. This is very beneficial as the water can be led into the conventional biosystem of a sewage treatment plant that demands a large quantity of dissolved oxygen. The retention time (typically 6-24 h) can also be increased in order to increase the pH while maintaining the same biobed amount. The retention time can vary largely depending on needs. Even such short retention times of one hour can be used in order to give at least some cleaning at conditions close to flooding and heavy rain fall.

This invention relies on factors comprising: the utilization of biological processes, preferably sunlight as energy and light source, the inherent temperature of the water; and the heat generated by the biological processes. As temperature and sun irradiance are highly variable over the year and even during a day, and the concentrations of nutrients vary as well, an efficient control and management of the system is necessary to achieve an effective and predictable cleaning of water.

At the inlet and down stream in the system the proportion of ammonium and nitrate can be measured. At high concentrations of ammonium, with high concentrations defined as “at levels negatively effecting growth of algae”, a larger proportion of the water can be forced to passage the oxygen free zones where there are no algae. This can be obtained by making the first section of the lower biobed longer before the water is forced up to the higher layer and water body. It can also be obtained, for example, by making the opening section into the lower biobed larger throughout the system and/or making the hindrance larger at the top layer. As the water is retained for a longer time at the bottom level, the ammonium levels are allowed to decrease at the top level, which dilutes the upcoming ammonium from the lower level.

The regulation of water flows may both be more permanent or on a shorter time scale. In water where large fluctuations in nutrient content are common, and parameters effecting water cleaning change rapid, water flow can be regulated on a daily basis with the help of a semi-automatic system closing and opening the entrance to the bottom layer and likewise regulate the size of the hindrance on the top layer.

At conditions where long term regulation of water is sufficient, the semi-automatic system is not necessary and a manual system will be constructed. The water can be regulated according to seasonal variation and as a backup to a sudden fall of algae biomass or at a change to different algal species.

The amount of water entering the system can be decreased and part of the water can be allowed to circulate to the beginning of the system at the inlet. Such solution will increase the amount of cleaning of all forms of nitrogen, phosphorus and BOD.

Limitations

Algal systems, as all biological systems, depend on seasonal variations. In Swedish latitudes the efficiency is strongly reduced during wintertime. However, in many applications the need of cleaning is reduced during winter. The efficiency of this invention should therefore be judged by its effect during a whole season. To enhance the efficiency different measures can be done. Reflective sheets may be used to increase the energy flow from sun. Artificial light may be considered in some cases. The channels may be covered with removable transparent sheets to increase/preserve the water temperature.

The system requires relative large areas. While the driving force is sunlight, the system may be seen as a light harvesting crop field. The light harvesting is particular high in algae compared to other crops but still large areas are required. The geometry of the system, however, is very flexible and the system may be divided into subsystems for maximum use of land areas.

The maintenance of the system is very low, but sediments, especially clayish sediment (mineral sediments with low organic content), may eventually reduce the efficiency of the system. This is, however, easily maintained by flushing the system when needed. High flows of sediments may also be trapped in a pre-sedimentation pond.

### Example 1

### A Medium-Size Wastewater Plant

The main aim of using this invention in a wastewater plant is to reduce the cost for the wastewater plant by reducing the pollutants in the water. The wastewater plant typically uses a combination of mechanical, chemical and biological methods to reduce the levels of nitrogen, phosphorus and biological oxygen demand (organic substances and nitrogen). These methods are very costly and by using this invention the cost may drastically be reduced. This invention may be added/complemented to the wastewater plant, typically after the treatment at the wastewater plant, but it may also be applied into intermediate steps in the systems. The wastewater plant may then reduce their efforts in their conventional system and this invention may “take over” a larger part of the cleaning process. No structural modifications are needed in the conventional system.

A shallow basin with a surface area from a few hundreds of square meters to a hectare is required. The size of the area depends on the desired treatment level of pollutants. Existing basins may be used; otherwise one or several basins must be constructed. The geometric form of the basin may have any form depending on the topology of available areas. The basin should preferably have a depth of about 0.6 meters but can both be deeper or shallower (0.3-1.0 m). The whole basin is covered with rubber sheeting. Sand may be added beneath the sheet for a smooth ground. The rubber sheet is not strictly required, other flexible material sustainable for long time in water, or light weight concrete, may work as well, but a rubber sheet is convenient, and economic.

In the basin, a channel system is constructed to lead the water in a meandering manner. The channelling walls are built up of rubber sheets. The walls, and if needed, the whole structure are held up by floating tubes, wires or other construction at the surface. At the bottom, the rubber wall is sealed against the bottom by the use of rocks.

In pre-existing ponds the floor may be too deep (>1 m) or the water level may fluctuate too much (>±0.2 m). In such ponds a floating solution is required. For instance, the whole structure may be held floating and supported with e.g. wood planks. The two-layered construction is the same but is held at right depth by floating units (e.g. fenders) and wrapped in rubber sheets (see FIG. 2). Some wooden support constructions may be required for a rigid construction. The greater depth may also be utilized as low-oxygen zones by using extended rubber sheets.

In the system of the invention, a suitable environment for algae and bacteria is created. About 20-40 cm of the bottom is covered with stones. The stones' size and exact composition depends on factors such as pH, desired flow rate and oxygen levels. Stones are covered with a permeable membrane, of geotextiles (Byggros AB, Levins vag 4, SE-291 73 0 nnestad, Sweden) or of glass fiber filter (Esska teknik AB, Karlstadsvägen 4, S-67142 Arvika) at mildly polluted water (below 15-20 nitrogen mg/L) to establish a low-oxygen environment. As many factors interact in a complex manner, different thicknesses of the membrane may be tested before the final installation and sand can be added between two sheets of geotextile. In our pilot plant, receiving outgoing sewage water, we tested geotextiles with sediments, which yields an oxygen concentration from under 0.5 mg/L to close to zero. When only using brick stones in a single layer biobed system, the oxygen content is often above 0.5 mg/L. The oxygen content and the need for using membranes of a certain thickness will depend on the amount of organic material in the water, how much breakdown is occurring (oxygen consumed) and how much oxygen is produced from the algae. A thicker net or mat (Byggros AB, Önnestad, Sweden) made for water use and anchored with stones or bricks can be used as substrate for nitrifying bacteria (FIG. 1)

Finally in a two-layer system, a second layer of stones or bricks is added on top of the membrane separator; and this will become the substrate for the algae and the nitrifying bacteria. This construction makes a two-layer system with low-oxygen and oxygen-rich zones. Oxygen moves from high to low oxygen level by diffusion and by flow at open areas in the membrane. The membrane layer thickness can be varied in order to fine-tune the diffusion rate of oxygen and nitrogen species. Larger openings (0.2 m²) at intervals of 3 meters in the membrane will ensure fast supply of nitrate for the de-nitrification process, as water mixing occur.

About every 5-10 meters, large obstacles are placed to mix the high and low oxygen waters more thoroughly. The water volume per m² is tuned typically for a flow rate in the order of a few dm/sec and is subjected for tight regulation. The system can also handle flow rates in the magnitude of liters per second per square meter. The total flow rate can also be changed by making the basin deeper. Especially the lower layer can be constructed deeper, since that layer is not dependent on sunlight for bacterial activity. A faster velocity benefits the algae as nutrients and carbon are continuously supplied. However, the pH needs to be monitored so it can reach up to pH 9 at the second half of the system, in order to allow for an efficient precipitation of phosphorus.

After a time (typically four weeks during summer) the algae are partly harvested. This gives maximum growth of the algae and biomass for energy production as well (handling of the biomass for energy production is not described in this invention).

### Example 2

### Runoff Waters from Agricultural Land

The heavy use of nutrients in agricultural activities causes major leakage (of nutrients such as nitrogen and phosphorus) to the landscape and recipients. Much of these nutrients are eventually transported in streams in the landscape. This invention is very suitable for, and easily applied, in such streams. The system of the invention can be constructed for a minimum environmental impact and alteration of natural occurring streams. It may be divided in several separated parts if desired and have little or no effect on the wildlife. For example, a parallel pond can be constructed next to the stream with an inlet upstream and an outlet downstream.

As in example 1, a two-layer system, with a membrane in between the layers, is constructed. The membrane might probably need to be thicker than in example 1, as the water from streams and runoff areas usually is more diluted and contains less oxygen-consuming particles. In order to calculate or estimate the thickness of the membrane, a smaller system can be constructed and the oxygen content can be measured below the membrane with an oxygen electrode. The wall system should be flexible, especially vertically for changes in water level as large fluctuations with periods with drought of heavy rain occur in semi-natural systems. In an agricultural landscape the sediment composition is different, and the mineral (clay) content is higher and should be trapped before entering the algal system. A buffering pond may be constructed upstream of the water treatment pond with algae and bacteria. Such a pond functions as a sediment trap. If the pond is to function as a sediment trap it needs to contain sufficient volume and to be deep enough to lower the stream velocity. The linear velocity needs to be lower than 0.3 msec in order to trap particles smaller than sand. However, in some cases, smaller particles can also sediment in the algal pond system and be broken down. Therefore, the sediment trap may have a velocity of 0.3 msec unless the water contains a greater amount of non-organic small particles that could be trapped in the algal pond system. The wall system is a meandering-like system (race pond) and consists of rubber mats attached to floating pipes. Ropes at both ends fasten the pipes and the ropes themselves are secured on a pole in the ground. The ropes are pulled tight with a certain amount of slack that allows upward and downward movements of the pipes. Since the pipes can move in these directions and are floating, the wall system adjusts flexibly to the variable water levels. Harvest is performed periodically as well as maintenance.

While the invention has been described with reference to specific embodiments, it will be appreciated that numerous variations, modifications, and embodiments are possible, and accordingly, all such variations, modifications, and embodiments are to be regarded as being within the spirit and scope of the invention.

### REFERENCES

A. Neba and P. D. Rose. Proceedings of the 2004 Water Institute of Southern Africa (WISA) Biennial Conference 2. 6 May 2004 ISBN: 1-920-01728-3 Cape Town, South Africa. Produced by: Document Transformation Technologies
Larsdotter, Karin (2006): Microalgae for phosphorus removal from wastewater in a Nordic climate. A doctoral thesis from the School of Biotechnology, Royal Institute of Technology, Stockholm, Sweden. ISBN: 91-7178-288-5
Higgins, Scott Neil. 2005, FIG. 5.3, Modeling the growth dynamics of Cladophora in eastern Lake Erie, PhD thesis, University of Waterloo, Waterloo, Ontario, Canada.
Oswald, W. J. and H. B. Gotaas, 1957. Photosynthesis in sewage treatment. Trans. Am. Soc. Civ. Eng., 122: 73-105.
Ed. Weast 1975. Handbook of Chemistry and Physics, R.C. CRC Press, Ohio. 1975

What is claimed is:

1. A waste water treatment system, comprising:
a) a basin for holding water;
b) nitrifying and denitrifying bacteria;
c) macroalgae; and
d) a biobed having at least one layer and being constructed of materials selected to allow pH adjustments for enabling bacterial and algal growth, in which biobed de-nitrification and nitrification bacterial processes are separated and wherein oxygen produced by algae is used by the nitrifying bacteria; and
wherein water is provided continuously to the biobed at an inlet and exits the system downstream after having gone through the biobed.

2. The waste water treatment system of claim 1, wherein the basin is covered with a flexible impermeable material.

3. The waste water treatment system of claim 1, wherein the basin is 0.3 to 1.0 m in depth.

4. The waste water treatment system of claim 1, wherein the biobed is constructed of materials selected from the group consisting of stones, bricks, broken concrete blocks, and leca grains.

5. The system of claim 1, wherein the biobed has a plurality of layers.

6. The waste water treatment system of claim 5, wherein the biobed comprises a lower low-oxygen layer for de-nitrifying bacteria and an upper layer for nitrifying bacteria to reduce nitrate to nitrogen gas and for algae to produce oxygen and grow to yield biomass.

7. The wastewater system of claim 1, wherein the system comprises a one-layer biobed with an oxygen concentration gradient

8. The waste water treatment system of claim 1, wherein the biobed is constructed at the bottom of a pool.

9. The waste water treatment system of claim 1, wherein the water is provided to the biobed in channels having walls and in multiple modules.

10. The waste water treatment system of claim 9, wherein the walls have tops that are held up so they float at the surface of the water.

11. The waste water treatment system of claim 1, further comprising nets inserted in the biobed.

12. The waste water treatment system of claim 6, wherein glass fiber nets are inserted in the lower layer and textile fiber mats are inserted in the upper layer.

13. The waste water treatment system of claim 5, wherein the system comprises a zone separator membrane to reduce oxygen in the lower layer.

14. The waste water treatment system of claim 13, wherein there are large openings at intervals of 3 meters in the zone separator membrane to ensure a fast supply of nitrate for the de-nitrification process.

15. The waste water treatment system of claim 1, wherein the macroalgae are Cladophora.

16. A method of treating waste water, comprising:
a) providing the waste water treatment system of claim 1; and
b) harvesting algae from the biobed.

17. The method of claim 16, wherein the process of de-nitrification is controlled by the amount of algae that is harvested.

18. The method of claim 16, further comprising using the harvested algae for biogas production and for fertilizer.

19. The method of claim 16, further comprising pre-fermentation and pre-sedimentation of the wastewater before it enters the waste water treatment system.

20. The method of claim 16, further comprising measuring ammonium and nitrate at the inlet and downstream, and using the measurement to regulate water flow through the lower layer.
